(19) United States
(12) Patent Application Publication
(10) Pub. No.: US 2005/0199098 A1
(43) Pub. Date: Sep. 15, 2005

(54) Bottle opener mounted to underside of horizontal surface

(76) Inventor: Bernard I. Levine, Torrance, CA (US)

Correspondence Address: Irving Keschner, Suite 1150, 21515 Hawthorne Boulevard, Torrance, CA, 90503, US

(21) Appl. No.: 10/799,138

(22) Filed: Mar. 12, 2004

(51) Int. Cl. B67B 7/00

(52) U.S. Cl. 81/3.25

(57) ABSTRACT

A bottle opener secured to the underside of a horizontal surface comprising a triangular shaped opener having an edge formed along the diagonal leg of the opener. A plurality of mounting holes are formed in the base of the opener so that fasteners can secure the opener to the underside of a horizontal surface, enabling a person to remove a bottle cap while positioned adjacent to the surface.

### BACKGROUND OF THE INVENTION

1. Field of the Invention

The present invention relates to a device for opening a bottle, the opener being secured under a horizontal surface. 2. Description of the Prior Art

Bottle openers have long been publicly available. Examples of such openers are disclosed in U.S. Pat. Nos. 2,810,311 to Smith, 2,053,246 to Larcott, 5,265,501 to Reyes, D257,318 to Zorzi and D382,783 to Martin.

The Reyes patent discloses a bottle cap opener attached to the upper edge on the rear wall of a housing, the bottle cap opener comprising an elongated downwardly curved hook member fabricated out of a durable metal material.

What is desired is to provide a bottle opener that is secured under a horizontal surface and in a manner such that the bottle opener is unobtrusive yet always available to a user.

### SUMMARY OF THE INVENTION

The present invention provides a bottle opener mounted to the underside of a horizontal surface in a manner such that it is unobtrusive while at the same time being available to a user.

The bottle opener comprises a triangular shaped member having a protrusion formed along the diagonal, or longer, edge of the member. A plurality of mounting holes are formed in the base of the opener so that fasteners can secure it to the underside of a horizontal surface enabling a person to remove a bottle cap while adjacent to the opener.

The present invention thus provides a simple and inexpensive bottle opener which enables a person to remove bottle caps, the opener being unobtrusive but always available for use. In addition, the opener of the present invention allows a bottle to be opened with one hand without the accuracy required with other mounted openers and can be affixed to any item having a horizontal surface with an accessible underside such as a desk, table, hutch, workbench, shelf, bar, coffee table, piano. The opener is preferably used in the kitchen and mounted in a manner such that it can be used without being seen.

### DESCRIPTION OF DRAWINGS

For a better understanding of the present invention as well as other objects and further features thereof, reference is made to the following description which is to be read in conjunction with the accompanying drawing wherein:

FIGS. 1 and 2 are perspective views illustrating the bottle opener of the present invention;

FIG. 3 is a cross-sectional view along line 3-3 of FIG. 2;

FIG. 4 illustrates the bottle opener of the present invention mounted on the underside of an upper kitchen cabinet; and

FIG. 5 is a cross-sectional view along line 5-5 of FIG. 4 illustrating the functioning edge of the opener.

### DESCRIPTION OF THE INVENTION

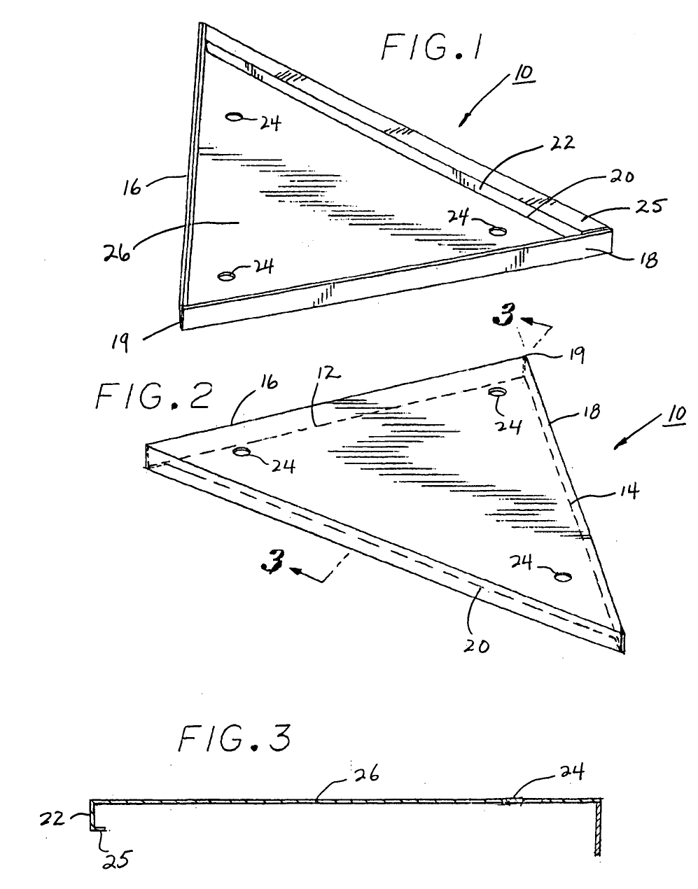

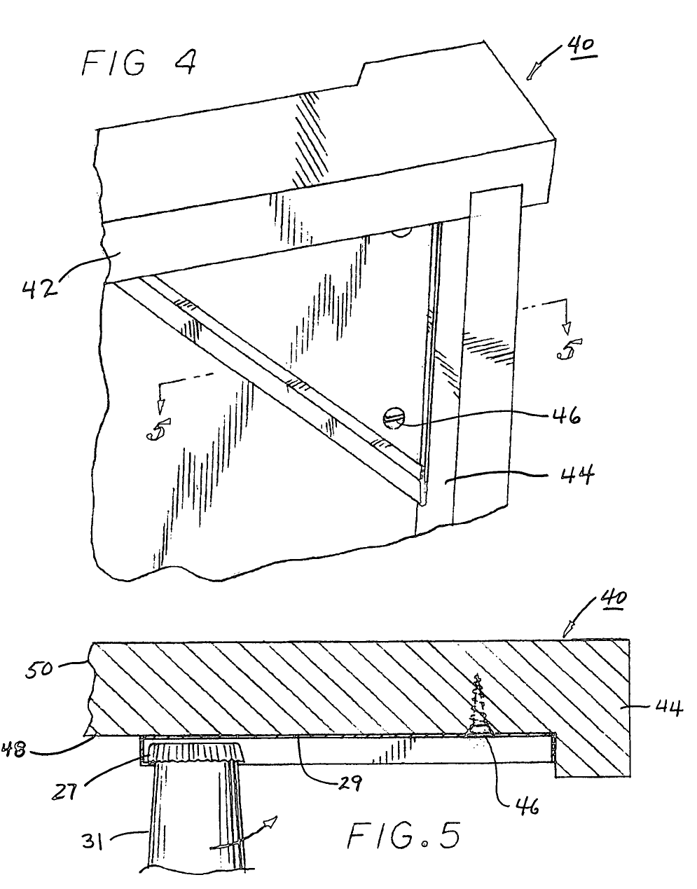

Referring now to FIGS. 1 and 2, perspective views of the top and bottom portions, respectively, of the bottle opener 10 of the present invention are illustrated. In the preferred configuration, opener 10 has a triangular shape having sides 12 and 14 with vertical portions 16 and 18, respectively, apex 19 and diagonal leg portion 20 having vertical portion 22. Edge 25, forming a lip extending from the top of portion 22, extends along the length of leg portion 20. A plurality of countersunk holes 24 are formed in base member 26 to enable opener 10 to be mounted to a surface. FIG. 3 is a cross-sectional view along line 3-3 of FIG. 2 clearly illustrating working edge 25. Edge 25 functions to remove bottle cap 27 as will be explained in more detail hereinafter with reference to FIGS. 4 and 5.

Opener 10 is preferably fabricated from metal, such as steel, although other materials can be used (if a non-metal is used, edge 25 must be fabricated from a strengthened material to enable bottle cap 27 to be removed). Typical dimensions for opener 10 are as follows:

| | |
|---|---|
| Sides 12 and 14: | 4 inches |
| Vertical portions 16 and 18: | 0.5 inches |
| Portion 20: | 5.66 inches |
| Vertical portion 22: | 0.125 inches |

These dimensions can be larger since the bottle cap 27 always will engage the working edge 25 as it moves away from apex 19. The opener 10 is sized so that the distance between the inner surface 25 of base member 26 and the inner surface of linking edge 25 as shown in FIG. 5 is slightly larger than the height of the bottle cap 27.

Referring now to FIG. 4, bottle opener 10 is shown, in a preferred configuration, mounted to the underside of kitchen cabinet 40.

Opener 10 is positioned such that vertical portions 16 and 18 are in contact against the side panels 42 and 44 of kitchen cabinet 40 respectively; flat head screws are then positioned in holes 24 (only a single screw 46 is illustrated) and fastened into the under surface 48 of upper board member 50 of kitchen cabinet 40; in this view, edge 25, is clearly illustrated.

Referring to FIG. 5, when it is desired to open a bottle 31 having a non-threaded cap 27, the capped bottle 31 is placed inside the corner of the cabinet 40 and moved away from apex 19 until cap 27 encounters working edge 25; the cap 27 will be pried off when a user rotates the bottle bottom towards apex 19.

It should be noted that the shape of opener 10 allows it to function without requiring the user to be concerned about the accurate positioning of the bottle cap 27. In particular, after the bottle cap 27 is within the area formed by the triangular shape of opener 10, removing bottle cap 27 requires no further alignment effort on the part of the user. In addition, since the bottle opener 10 is stationary, the entire length of the bottle 31 provides leverage for the opening operation, an important feature when many bottles are to be opened by the same operator.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A bottle opener for removing a bottle cap from a bottle and having a triangular shape and adapted for mounting to the underside of a horizontal surface, the opener having a base, first and second leg portions extending substantially perpendicular to said base and having first and second ends, a third leg extending substantially perpendicular to said base and coupled between said first ends of said first and second leg portions, said third leg having a first end and a horizontal edge portion having our outer surface and extending from said first end, said horizontal edge portion engaging and removing said bottle cap, the distance between said inner surface of said horizontal edge portion and said base being greater than the height of said bottle cap, holes being formed in said base and adapted to receive fasteners to secure said opener to said horizontal surface.

2-3. (canceled)

4. The bottle opener of claim 1 wherein said horizontal edge portion extends substantially the entire length of said third leg.
